(19) United States
(12) Patent Application Publication
(10) Pub. No.: US 2025/0340057 A1
(43) Pub. Date: Nov. 6, 2025

(54) INK-JET HEAD

(71) Applicant: Panasonic Intellectual Property Management Co., Ltd., Osaka (JP)

(72) Inventors: SHUHEI NAKATANI, Osaka (JP); FUTOSHI OHTSUKA, Kyoto (JP); KAZUNOBU IRIE, Hyogo (JP)

(21) Appl. No.: 19/265,671

(22) Filed: Jul. 10, 2025

Related U.S. Application Data
(63) Continuation of application No. PCT/JP2023/044924, filed on Dec. 14, 2023.

(30) Foreign Application Priority Data
Feb. 9, 2023 (JP) 2023-018333

(51) Int. Cl. B41J 2/14; B41J 2/17; B41J 2/175

(52) U.S. Cl. CPC B41J 2/14233; B41J 2/1721; B41J 2/175

(57) ABSTRACT

An ink-jet head includes a head body including a nozzle that ejects ink and an inner surface that is in contact with the ink, and a protective film covering a whole of the inner surface of the head body.

### TECHNICAL FIELD

The present disclosure relates to an ink-jet head.

### BACKGROUND ART

In recent years, ink-jet printers have been used for manufacturing electronic devices such as liquid crystal panels and organic EL panels. Known examples of an ink-jet head include a drop-on-demand ink-jet head capable of ejecting a necessary number of ink droplets to a coating object at necessary timing with high accuracy by high frequency driving (e.g., 50 kHZ). This type of ink-jet head generally includes an ink flow path, a pressure chamber that is connected to the ink flow path and stores ink, a piezoelectric element (piezo element) that pressurizes the ink stored in the pressure chamber, a nozzle that communicates with the pressure chamber, and the like (e.g., see PTL 1). When the piezoelectric element is energized to pressurize the ink in the pressure chamber, ink droplets are ejected from the nozzle.

### CITATION LIST

### Patent Literature

PTL 1: Unexamined Japanese Patent Publication No. 2003-326703

### SUMMARY OF THE INVENTION

An ink-jet head according to an aspect of the present disclosure includes a head body including a nozzle that ejects ink, and a protective film covering the whole of an inner surface of the head body.

### BRIEF DESCRIPTION OF THE DRAWINGS

FIG. 1 is a schematic diagram illustrating an example of a configuration of a printer according to the present exemplary embodiment.

FIG. 2 is a schematic diagram schematically illustrating an ink-jet head of FIG. 4.

FIG. 3 is a perspective view schematically illustrating a head body of FIG. 4.

FIG. 4 is an exploded perspective view illustrating an example of an appearance of an ink-jet head according to the present exemplary embodiment.

FIG. 5 is a sectional view schematically illustrating an example of an ink flow path in the ink-jet head of FIG. 4.

FIG. 6 is a sectional view schematically illustrating an example of an ink flow path in the ink-jet head of FIG. 4.

FIG. 7 is a plan view of a first example showing a relationship among an upstream common flow path, a connection flow path, and an ink supply path.

FIG. 8 is a plan view of a second example showing a relationship among an upstream common flow path, a connection flow path, an ink supply path, and an ink discharge path.

FIG. 9 is a plan view of a third example showing a relationship among an upstream common flow path, a downstream common flow path, a connection flow path, an ink supply path, and an ink discharge path.

FIG. 10 is a plan view of a fourth example showing a relationship among an upstream common flow path, a downstream common flow path, and a connection flow path.

FIG. 11 is a plan view illustrating a first modification of the fourth example illustrated in FIG. 10.

FIG. 12 is a plan view illustrating a second modification of the fourth example illustrated in FIG. 10.

FIG. 13 is a flowchart showing an example of a flow of a film forming processing for the ink-jet head according to the present exemplary embodiment.

### DESCRIPTION OF EMBODIMENT

When an electronic device is manufactured using a coating apparatus, various materials need to be formed into ink, and may be formed into ink using a solvent with strong solubility. Ink containing such a solvent with strong solubility may dissolve a liquid contact surface of an ink-jet head. In particular, when the ink-jet head is formed by stacking a plurality of plates and bonding the respective plates with an adhesive, an adhesive layer is exposed to the liquid contact surface, and thus causing the adhesive layer to be likely to be damaged by the solvent. When the adhesive layer is damaged by the solvent, peeling occurs between members, and thus causing ink to fail to accumulate, ink leakage, and deterioration in ink ejection performance.

The present disclosure has been made in view of the problems in the prior art, and an object thereof is to provide an ink-jet head that can be improved in chemical resistance to ink.

Hereinafter, exemplary embodiments of the present disclosure will be described with reference to the drawings. The present disclosure is not limited to the exemplary embodiments below, and various modifications can be made without departing from the gist of the present disclosure. The present disclosure also includes all combinations of configurations that can be combined in configurations illustrated in the respective exemplary embodiments below. Then, a component with a same reference numeral illustrated in each drawing shows the same or equivalent component, and this is common in the entire specification.

Hereinafter, exemplary embodiments of the present disclosure will be described with reference to the drawings. A printer according to the present exemplary embodiment forms an image on a printing target object by ejecting ink onto the printing target object.

### Configuration of Printer 1000

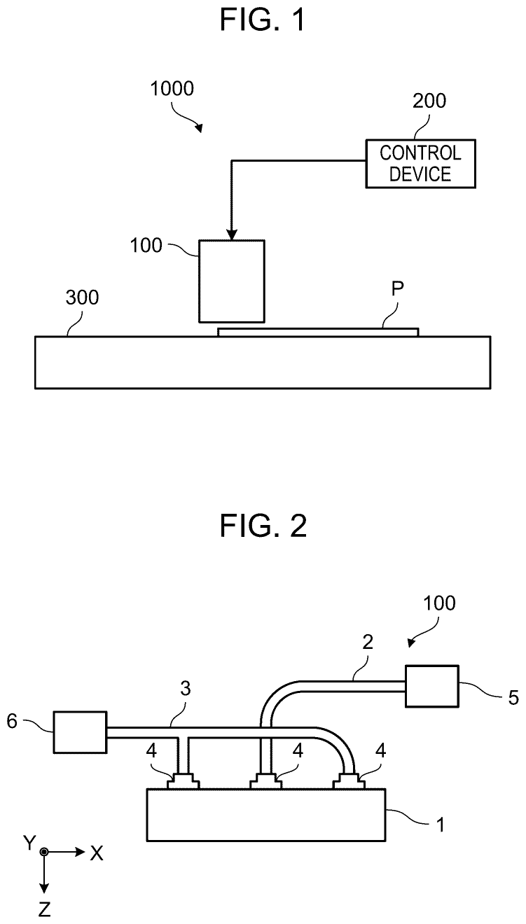

FIG. 1 is a schematic diagram illustrating an example of a configuration of printer 1000 according to the present exemplary embodiment. As illustrated in FIG. 1, printer 1000 includes ink-jet head 100, control device 200, and stage 300. On stage 300, printing target object P is placed.

Ink-jet head 100 ejects ink droplets onto printing target object P placed on stage 300. Operation of ink-jet head 100 including the ejection of the ink droplets is controlled by control device 200.

Control device 200 controls the whole of printer 1000. For example, control device 200 receives print image data from an external host PC, and forms an image on printing target object P based on the received print image data. At that time, control device 200 controls ejection timing of the ink droplets from ink-jet head 100 and a volume of the ink droplets in conjunction with operation of stage 300.

Stage 300 is configured to be relatively movable with respect to ink-jet head 100, for example, and conveys placed printing target object P. Then, stage 300 changes a relative positional relationship between printing target object P and ink-jet head 100 by conveying printing target object P.

Although stage 300 is described to be movable in this example, the configuration of printer 1000 is not limited to this example. For example, printer 1000 may be configured such that stage 300 is fixed and ink-jet head 100 moves, or may be configured such that both ink-jet head 100 and stage 300 move.

### Ink-Jet Head 100

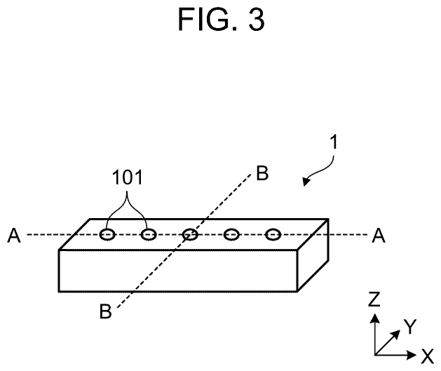

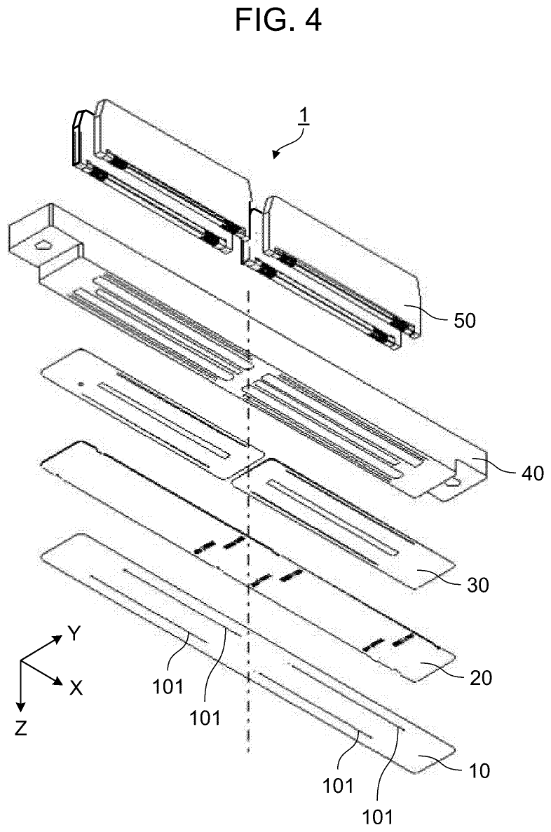

FIG. 2 is a schematic diagram schematically illustrating ink-jet head 100 of FIG. 4. FIG. 3 is a perspective view schematically illustrating head body 1 of FIG. 4. As illustrated in FIG. 2, ink-jet head 100 includes head body 1, supply pipe 2, collection pipe 3, joint 4, ink supply tank 5, and ink collection tank 6.

Head body 1 is an ink circulation type in which ink circulates, for example. As illustrated in FIG. 3, head body 1 includes a plurality of nozzles 101, and ejects the ink formed into droplets from the plurality of nozzles 101 under control of control device 200. Head body 1 is configured such that the ink stored in ink supply tank 5 is injected from a liquid injection port (not illustrated) through supply pipe 2 by a circulation pump (not illustrated) and circulates to be discharged from a discharge port (not illustrated). The discharged ink is collected in ink collection tank 6 through collection pipe 3. For ink-jet head 100 of an ink circulation type, ink collection tank 6 may be eliminated. This ink-jet head is configured such that collection pipe 3 is connected to ink supply tank 5, and the ink discharged from the discharge port returns to ink supply tank 5 through collection pipe 3. Alternatively, the ink-jet head may be configured such that ink supply tank 5 and ink collection tank 6 are connected by a pipe (not illustrated), for example, and the ink collected in ink collection tank 6 returns to ink supply tank 5 through the pipe using a circulation pump (not illustrated).

Supply pipe 2 is provided to connect ink supply tank 5 to a liquid injection port (not illustrated) of head body 1 using joint 4 to inject the ink supplied from ink supply tank 5 into head body 1. Collection pipe 3 is provided to connect ink collection tank 6 to the liquid discharge port (not illustrated) of head body 1 using joint 4 to supply the ink discharged from head body 1 to ink collection tank 6. Joint 4 is provided to connect supply pipe 2 or collection pipe 3 to head body 1.

### Head Body 1

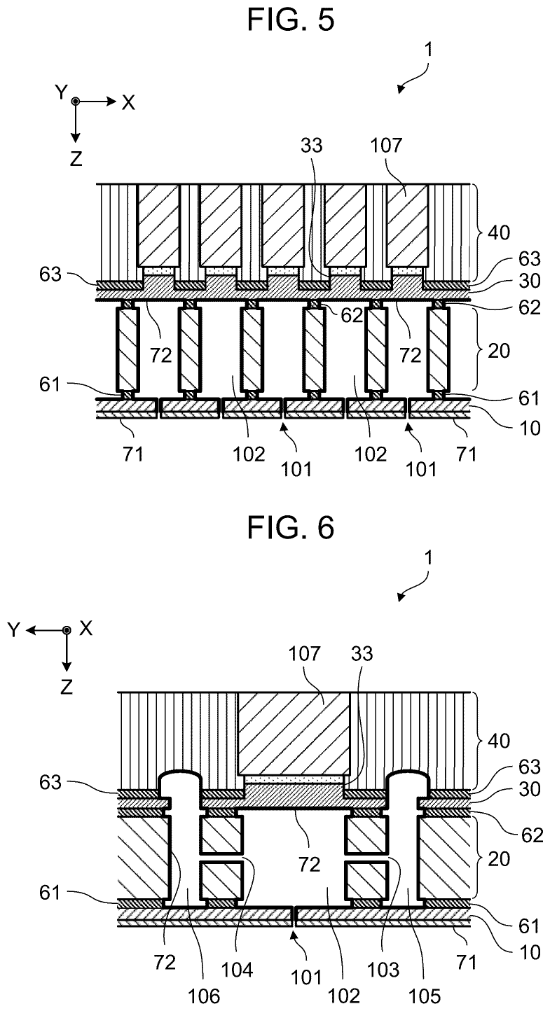

FIG. 4 is an exploded perspective view illustrating an example of an appearance of head body 1 according to the present exemplary embodiment. FIGS. 5 and 6 are each a sectional view schematically illustrating an example of an ink flow path in head body 1. FIG. 5 illustrates a section taken along line A-A in FIG. 3, and FIG. 6 illustrates a section taken along line B-B in FIG. 3.

The present exemplary embodiment will be described using a rectangular coordinates system (X, Y, Z). The rectangular coordinates system includes a Z axis that has a positive direction in which head body 1 discharges ink, an X axis along which nozzles 101 are arranged, and a Y axis along which the ink flows through an ink flow path (upstream individual flow path 103 and downstream individual flow path 104) connected to pressure chamber 102. In the description below, directions along the X axis, the Y axis, and the Z axis are referred to as an “X axis direction”, a “Y axis direction”, and a “Z axis direction”, respectively.

As illustrated in FIG. 4, head body 1 includes nozzle plate 10, flow path plate 20, vibration plate 30, housing 40, and pressure fluctuation unit 50. Each of pairs of: nozzle plate 10 and flow path plate 20; flow path plate 20 and vibration plate 30; vibration plate 30 and housing 40; and vibration plate 30 and pressure fluctuation unit 50, is bonded and fixed with an adhesive. Available examples of the adhesive include an epoxy-based adhesive having thermosetting characteristics. As adhesives for bonding respective members, an identical adhesive may be used, or different adhesives may be used. For example, a rubber-based adhesive may be used for bonding predetermined members, and an epoxy-based adhesive may be used for bonding other members.

Nozzle plate 10 is disposed with its plate surface orthogonal to the Z axis. Nozzle plate 10 is made of a stainless steel plate formed by etching or press working, for example. The stainless steel plate has a thickness of 100 μm, for example.

Flow path plate 20 is formed in a rectangular parallelepiped shape, and is disposed on a negative side of nozzle plate 10 in the Z axis direction with its plate surface orthogonal to the Z axis. Flow path plate 20 is sandwiched between vibration plate 30 and nozzle plate 10. Flow path plate 20 is a stacked body of a plurality of stainless steel plates formed by etching or press working, for example. Each of the stainless steel plates has a thickness in a range from 10 μm to 100 μm, inclusive, for example, and three to ten layers of the stainless steel plates are formed, for example.

Vibration plate 30 is a diaphragm, for example, and is disposed on the negative side of flow path plate 20 in the Z axis direction with its plate surface orthogonal to the Z axis. Vibration plate 30 is sandwiched between housing 40 and flow path plate 20. Vibration plate 30 is a thin film having a thickness of 5 μm to 50 μm, for example, and is made of stainless steel, nickel alloy, or polyimide, for example. Vibration plate 30 includes pressure receivers 33 that receive fluctuation of respective piezoelectric elements 107 (see FIGS. 5 and 6). Pressure receivers 33 are provided corresponding to respective pressure chambers 102 formed in flow path plate 20, and are formed protruding toward the negative side in the Z axis direction, for example. Vibration plate 30 may include no pressure receiver 33. That is, vibration plate 30 may include no protrusion immediately below piezoelectric element 107, and may have a substantially flat plate shape.

Housing 40 is formed in a rectangular parallelepiped shape and is disposed on the negative side of vibration plate 30 in the Z axis direction. Housing 40 has a thickness of 1 cm in the Z axis direction, for example. Housing 40 is formed by cutting alloy steel such as stainless steel, for example.

Housing 40 is provided with a housing chamber (not illustrated) in which pressure fluctuation unit 50 is disposed. Pressure fluctuation unit 50 includes piezoelectric element 107 (see FIGS. 5 and 6).

As illustrated in FIGS. 5 and 6, head body 1 includes nozzles 101, pressure chambers 102, upstream individual flow paths 103, downstream individual flow paths 104, upstream common flow paths 105, downstream common flow paths 106, piezoelectric elements 107, and the like. Nozzles 101, pressure chambers 102, upstream individual flow paths 103, downstream individual flow paths 104, upstream common flow paths 105, and downstream common flow paths 106 are formed inside nozzle plate 10, flow path plate 20, vibration plate 30, and housing 40, or formed by bonding them.

Between nozzle plate 10 and flow path plate 20, first adhesive layer 61 is interposed. Between flow path plate 20 and vibration plate 30, second adhesive layer 62 is interposed. Between vibration plate 30 and housing 40, third adhesive layer 63 is interposed. First adhesive layer 61, second adhesive layer 62, and third adhesive layer 63 partially constitute pressure chamber 102, upstream common flow path 105, and downstream common flow path 106. That is, first adhesive layer 61, second adhesive layer 62, and third adhesive layer 63 each serve as a liquid contact surface with which ink comes into contact in the ink flow path. Each of first adhesive layer 61, second adhesive layer 62 and third adhesive layer 63 contains an organic substance and is likely to be dissolved in the ink, and thus is said to be a part that is particularly required to be protected by protective film 72 described later. Although details are not described, an adhesive layer different from third adhesive layer 63 is interposed also between vibration plate 30 and piezoelectric element 107.

The plurality of nozzles 101 is drilled in nozzle plate 10 along the X axis. Nozzle 101 is a hole passing through nozzle plate 10 in the Z axis direction. An ink droplet is ejected to the outside through nozzle 101. Nozzles 101 each have a diameter of about 10 μm to 50 μm, and about 100 to 300 nozzles are arranged at intervals of 100 μm to 500 μm, for example. Nozzle 101 is made of stainless steel, silicon, or polyimide, for example.

Nozzles 101 may be disposed in one row or in a plurality of rows along the X axis. FIG. 4 illustrates an example in which nozzles 101 are disposed in two rows along the X axis. When nozzles 101 are disposed in a plurality of rows, pressure chamber 102, upstream individual flow path 103, downstream individual flow path 104, upstream common flow path 105, and downstream common flow path 106 are provided for each nozzle row.

Nozzle plate 10 has a surface on a positive side in the Z axis direction, the surface being provided with liquid-repellent film 71. Liquid-repellent film 71 has a property of repelling ink. Liquid-repellent film 71 is made of a fluorine-based resin, a polyimide resin, or fluorine-based diamond-like carbon, for example. No protective film 72 is formed on liquid-repellent film 71.

Pressure chamber 102 is formed by closing an open surface (a surface on the negative side in the Z axis direction) of a recess formed in flow path plate 20 with vibration plate 30. Pressure chamber 102 is an ink storage space that stores ink. Pressure chamber 102 is provided corresponding to each of the plurality of nozzles 101 and communicates with corresponding one of nozzles 101. Pressure chamber 102 is formed in a rectangular parallelepiped shape extending along the Y axis, for example. Pressure chamber 102 may be provided on its inner surface with a step.

Pressure chamber 102 is configured to appropriately accumulate pressure generated by deformation of piezoelectric element 107, thereby generating energy for ejection ink from nozzle 101. Pressure chamber 102 is connected to upstream individual flow path 103 to which ink is supplied, and a connection part between pressure chamber 102 and upstream individual flow path 103 is a throttle having a narrower width than other flow paths. Consequently, the pressure is appropriately accumulated in pressure chamber 102. Pressure chamber 102 is made of stainless steel or silicon, for example.

Upstream individual flow path 103 is disposed upstream of pressure chamber 102 in an ink flow direction to allow pressure chamber 102 to communicate with upstream common flow path 105. Upstream individual flow path 103 is provided corresponding to each of the plurality of pressure chambers 102.

Downstream individual flow path 104 is disposed downstream of pressure chamber 102 in the ink flow direction to allow pressure chamber 102 to communicate with downstream common flow path 106. Downstream individual flow path 104 is provided corresponding to each of the plurality of pressure chambers 102.

Upstream common flow path 105 is an ink storage space disposed upstream of upstream individual flow path 103 in the ink flow direction. Upstream common flow path 105 is provided in common to the plurality of upstream individual flow paths 103. Upstream common flow path 105 communicates with ink supply path 112 (described later) formed in housing 40 through opening 31 formed in vibration plate 30.

Downstream common flow path 106 is an ink storage space disposed downstream of downstream individual flow path 104 in the ink flow direction. Downstream common flow path 106 is provided in common to the plurality of downstream individual flow paths 104. Downstream common flow path 106 communicates with ink discharge path 113 (described later) formed in housing 40 through opening 32 formed in vibration plate 30.

Piezoelectric element 107 is provided corresponding to each of the plurality of pressure chambers 102, and is in contact with pressure receiver 33 of vibration plate 30. Piezoelectric element 107 is deformed to expand and contract in the Z axis direction, for example, when voltage is applied to piezoelectric element 107. Piezoelectric element 107 is made of lead zirconate titanate (PZT), for example.

### Connection Flow Path 111, Ink Supply Path 112, and Ink Discharge Path 113

Head body 1 includes connection flow path 111, ink supply path 112, and ink discharge path 113 that are formed between ink supply tank 5 and ink collection tank 6.

### FIRST EXAMPLE

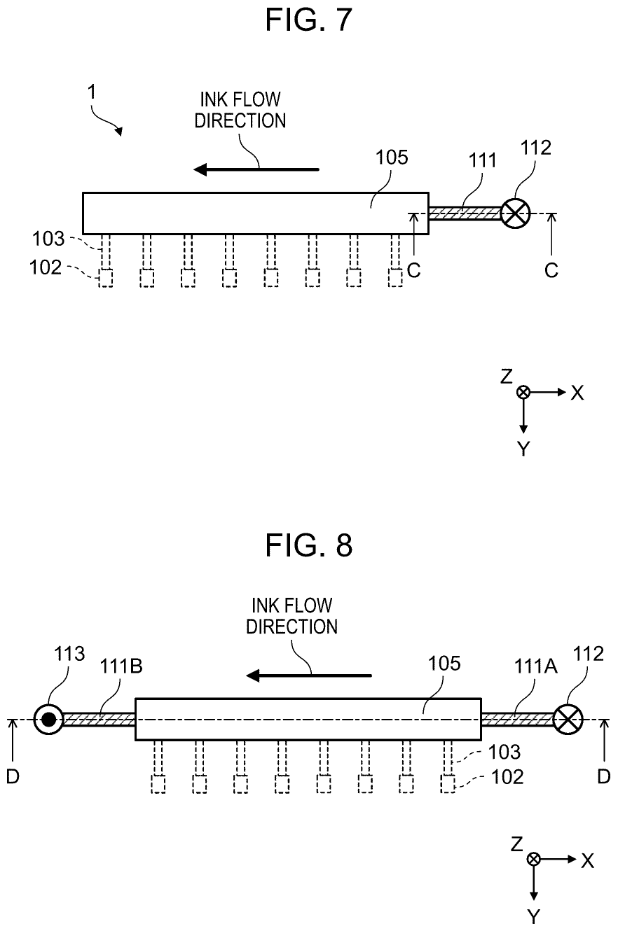

FIG. 7 is a plan view of a first example showing a relationship among upstream common flow path 105, connection flow path 111, and ink supply path 112.

As illustrated in FIG. 7, one end of connection flow path 111 is connected to an upstream end part of upstream common flow path 105. Connection flow path 111 is formed in a shape having a sectional area smaller than that of upstream common flow path 105. For example, ink supply path 112 is connected to the other end of connection flow path 111. When connection flow path 111 is formed inside flow path plate 20, the connection flow path is not represented by a solid line in plan view, but is represented by a hatching pattern illustrated in FIG. 7 to illustrate a concept. When the connection flow path is illustrated in the following drawings, the connection flow path may be represented by a similar hatching pattern.

### SECOND EXAMPLE

FIG. 8 is a plan view of a second example showing a relationship among upstream common flow path 105, connection flow paths 111A and 111B, ink supply path 112, and ink discharge path 113.

As illustrated in FIG. 8, one end of connection flow path 111A is connected to an upstream end part of upstream common flow path 105, the one end having a smaller sectional area than upstream common flow path 105. Ink supply path 112 is connected to the other end of continuous flow path 111A. One end of connection flow path 111B is connected to a downstream end part of upstream common flow path 105, the one end having a smaller sectional area than upstream common flow path 105. Ink discharge path 113 is connected to the other end of connection flow path 111B.

This kind of configuration allows ink having flowed through upstream common flow path 105 to return to upstream common flow path 105 through ink discharge path 113, ink collection tank 6, circulation pump (not illustrated), ink supply tank 5, and ink supply path 112.

### THIRD EXAMPLE

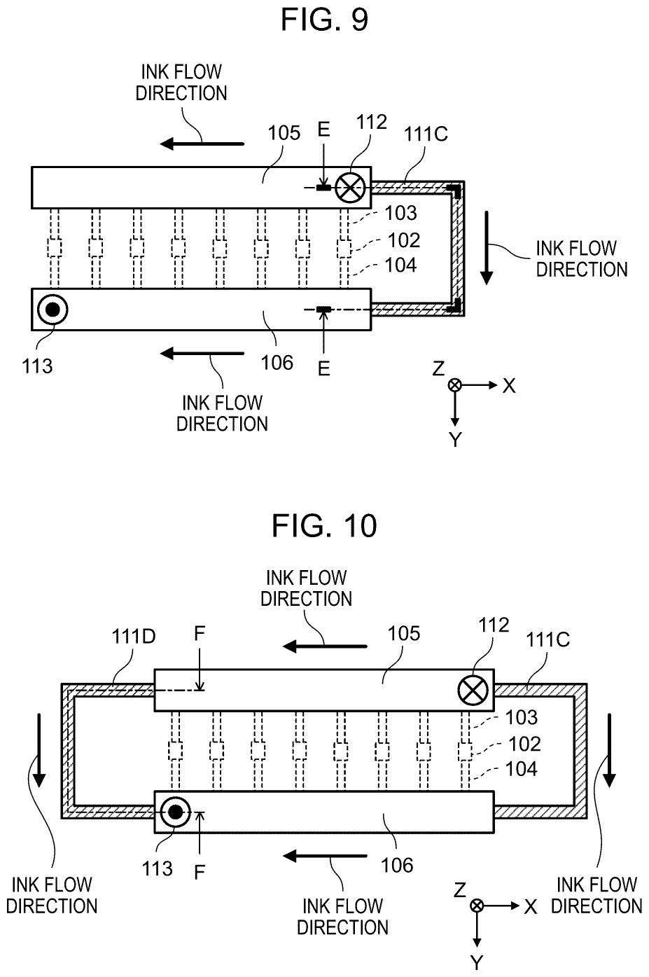

FIG. 9 is a plan view of a third example showing a relationship among upstream common flow path 105, downstream common flow path 106, connection flow path 111C, ink supply path 112, and ink discharge path 113.

As illustrated in FIG. 9, one end of connection flow path 111C is connected to an upstream end part of upstream common flow path 105, the one end having a smaller sectional area than upstream common flow path 105. The other end of connection flow path 111C is connected to an upstream end part of downstream common flow path 106. Ink supply path 112 is connected to an upstream side of upstream common flow path 105. Ink discharge path 113 is connected to a downstream side of downstream common flow path 106.

This kind of configuration allows ink having flowed through upstream common flow path 105 to partially flow to ink discharge path 113 through individual flow paths 103 and 104, and downstream common flow path 106. The rest of ink supplied from ink supply path 112 flows to ink discharge path 113 through connection flow path 111C and downstream common flow path 106. The ink having flowed through ink discharge path 113 is returned to upstream common flow path 105 through ink collection tank 6, a circulation pump (not illustrated), ink supply tank 5, and ink supply path 112.

### FOURTH EXAMPLE

FIG. 10 is a plan view of a fourth example showing a relationship among upstream common flow path 105, downstream common flow path 106, and connection flow paths 111C and 111D.

As illustrated in FIG. 10, one end of connection flow path 111D is connected to a downstream end part of upstream common flow path 105, the one end having a smaller sectional area than upstream common flow path 105. The other end of connection flow path 111D is connected to a downstream end part of downstream common flow path 106.

This kind of configuration allows ink having flowed through upstream common flow path 105 to partially flow to ink discharge path 113 through individual flow paths 103 and 104, and downstream common flow path 106, or through connection flow path 111D. The rest of ink supplied from ink supply path 112 flows to ink discharge path 113 through connection flow path 111C and downstream common flow path 106. The ink having flowed through ink discharge path 113 is returned to upstream common flow path 105 through ink collection tank 6, a circulation pump (not illustrated), ink supply tank 5, and ink supply path 112.

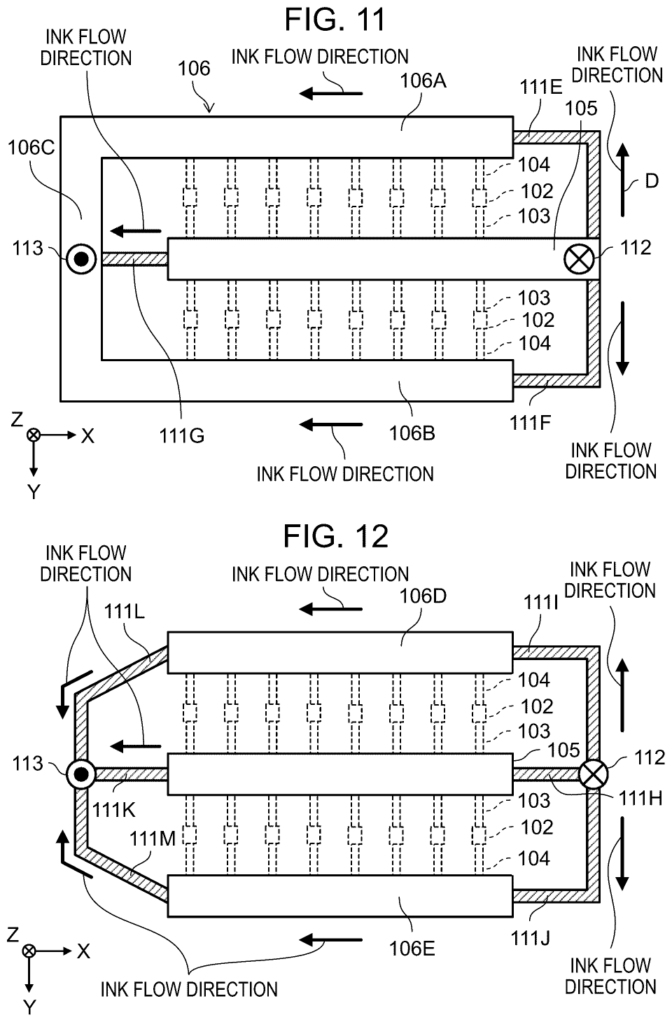

To miniaturize ink-jet head 100, upstream common flow path 105 or downstream common flow path 106 may be commonly used for a plurality of nozzle rows. FIG. 11 is a plan view illustrating a first modification of the fourth example illustrated in FIG. 10. FIG. 12 is a plan view illustrating a second modification of the fourth example illustrated in FIG. 10.

As illustrated in FIG. 11, upstream common flow path 105 is formed extending in the X-axis direction in plan view. In plan view, downstream common flow path 106 includes first part 106A formed extending in the X-axis direction on a +Y direction side of upstream common flow path 105, second part 106B formed extending in the X-axis direction on a −Y direction side of upstream common flow path 105, and third part 106C connecting end parts of first part 106A and second part 106B to each other on a −X direction side.

Ink supply path 112 is connected to a +X direction side end of upstream common flow path 105. Ink discharge path 113 is connected to the center in a longitudinal direction of third part 106C of downstream common flow path 106. Upstream common flow path 105 and first part 106A of downstream common flow path 106 are connected using a plurality of upstream individual flow paths 103, a plurality of pressure chambers 102, and a plurality of downstream individual flow paths 104. Upstream common flow path 105 and second part 106B of downstream common flow path 106 are connected using a plurality of upstream individual flow paths 103, a plurality of pressure chambers 102, and a plurality of downstream individual flow paths 104.

One end of connection flow path 111E and one end of connection flow path 111F are connected to the +X direction-side end part of upstream common flow path 105. The other end of connection flow path 111E is connected to a +X direction-side end part of first part 106A of downstream common flow path 106. The other end of connection flow path 111F is connected to a +X direction-side end part of second part 106B of downstream common flow path 106.

One end of connection flow path 111G is connected to a −X direction-side end part of upstream common flow path 105. The other end of connection flow path 111G is connected to near a connection part with ink discharge path 113 in third part 106C of downstream common flow path 106. Each of connection flow paths 111E, 111F, and 111G is formed with a sectional area smaller than a sectional area of upstream common flow path 105.

The configuration described above allows ink supplied from ink supply path 112 to partially flow in the −X direction through upstream common flow path 105. Then, the ink flows to first part 106A or second part 106B of downstream common flow path 106 through upstream individual flow paths 103, pressure chambers 102, and downstream individual flow paths 104, or flows to ink discharge path 113 through connection flow path 111G and third part 106C. The rest of the ink supplied from ink supply path 112 flows to ink discharge path 113 through connection flow path 111E, first part 106A, and third part 106C, or through connection flow path 111F, second part 106B, and third part 106C. The ink having flowed through ink discharge path 113 is returned to upstream common flow path 105 through ink collection tank 6, a circulation pump (not illustrated), ink supply tank 5, and ink supply path 112.

Alternatively, ink-jet head 100 may be configured as illustrated in FIG. 12 to lengthen the connection flow path and dispose many steps (steps each caused by a sectional area of the connection flow path, the sectional area being smaller than that of the common path). Ink-jet head 100 includes upstream common flow path 105, first downstream common flow path 106D, and second downstream common flow path 106E. Upstream common flow path 105, first downstream common flow path 106D, and second downstream common flow path 106E are formed extending in the X-axis direction in plan view. Upstream common flow path 105 and first downstream common flow path 106D are connected using a plurality of upstream individual flow paths 103, a plurality of pressure chambers 102, and a plurality of downstream individual flow paths 104. Upstream common flow path 105 and second downstream common flow path 106E are connected using a plurality of upstream individual flow paths 103, a plurality of pressure chambers 102, and a plurality of downstream individual flow paths 104.

One end of connection flow path 111H is connected to the +X direction-side end part of upstream common flow path 105. The other end of connection flow path 111H is connected to ink supply path 112. Ink supply path 112 is connected to one end of connection flow path 111I and one end of connection flow path 111J. The other end of connection flow path 111I is connected to a +X direction-side end part of first downstream common flow path 106D. The other end of connection flow path 111J is connected to a +X direction-side end part of second downstream common flow path 106E. One end of connection flow path 111K is connected to a −X direction-side end part of upstream common flow path 105. The other end of connection flow path 111K is connected to ink discharge path 113. Ink discharge path 113 is connected to one end of connection flow path 111L and one end of connection flow path 111M. The other end of connection flow path 111L is connected to a −X direction-side end part of first downstream common flow path 106D. The other end of connection flow path 111M is connected to a −X direction-side end part of second downstream common flow path 106E. Each of connection flow paths 111H, 111I, 111J, 111K, 111L, and 111M is formed with a sectional area smaller than a sectional area of upstream common flow path 105.

The configuration described above allows ink supplied from ink supply path 112 to flow to upstream common flow path 105 through connection flow path 111H. The ink having flowed to upstream common flow path 105 flows to first downstream common flow path 106D or second downstream common flow path 106E through upstream individual flow paths 103, pressure chambers 102, and downstream individual flow paths 104, or flows to ink discharge path 113 through connection flow path 111K. The rest of the ink supplied from ink supply path 112 flows to first downstream common flow path 106D through connection flow path 111I or flows to second downstream common flow path 106E through connection flow path 111J. The ink having flowed to first downstream common flow path 106D flows to ink discharge path 113 through connection flow path 111L. The ink having flowed to second downstream common flow path 106E flows to ink discharge path 113 through connection flow path 111M. The ink having flowed through ink discharge path 113 is returned to upstream common flow path 105 through ink collection tank 6, a circulation pump (not illustrated), ink supply tank 5, and ink supply path 112.

### Flow of Ink

Next, a flow of ink in ink-jet head 100 according to the present exemplary embodiment will be described. As illustrated in FIG. 2, when the ink is discharged from ink supply tank 5 provided in ink-jet head 100, the discharged ink is supplied to head body 1 through supply pipe 2 and joint 4.

As illustrated in FIG. 7, the ink supplied to head body 1 is supplied to upstream common flow path 105 through ink supply path 112. As illustrated in FIG. 6, the ink supplied to upstream common flow path 105 is supplied to pressure chamber 102 through upstream individual flow path 103. The ink supplied to pressure chamber 102 is discharged from ink discharge path 113 through downstream individual flow path 104 and downstream common flow path 106. Consequently, the ink is discharged from head body 1.

The ink discharged from head body 1 is circulated to ink supply tank 5 through joint 4 and collection pipe 3 by using a circulation pump (not illustrated), for example. When the ink is circulated without remaining in this manner, the ink can be prevented from remaining in pressure chamber 102 or nozzle 101 and causing nozzle clogging. Besides this, the ink discharged from head body 1 may be collected in ink collection tank 6 by the circulation pump (not illustrated), and then circulated to ink supply tank 5 through a pipe (not illustrated) connecting ink supply tank 5 to ink collection tank 6, for example.

Head body 1 of an ink circulation type includes ink supply tank 5 connected to ink supply path 112, the ink supply tank being under pressure set higher than pressure in ink collection tank 6 connected to ink discharge path 113. For example, difference in pressure can be controlled by changing positions in the Z axis direction (height with reference to pressure chamber 102) of ink supply tank 5 and ink collection tank 6. Alternatively, internal pressure of ink supply tank 5 and ink collection tank 6 may be individually controlled by a regulator, for example.

When voltage is applied to piezoelectric element 107 in head body 1, piezoelectric element 107 is deformed and extended in the Z axis direction, for example, and then vibration in the Z axis direction is transmitted to pressure receiver 33 of vibration plate 30. Consequently, vibration plate 30 is deformed to cause pressure fluctuation in the ink stored in pressure chamber 102. This pressure fluctuation propagating toward nozzle 101 causes an ink droplet to be discharged from nozzle 101.

### Formation of Protective Film 72

In the present exemplary embodiment, the ink ejected from head body 1 uses a polar organic solvent such as dimethylformamide as a main solvent, and a lead iodide compound or the like as a solute, for example. Thus, vibration plate 30 may corrode, or adhesives used for first adhesive layer 61, second adhesive layer 62, and third adhesive layer 63 may swell.

When vibration plate 30 corrodes, displacement energy generated when piezoelectric element 107 is deformed is not transmitted to the ink. Thus, ejection speed of ink droplets from nozzle 101 may decrease. Then, the ink may leak from a corroded part of vibration plate 30 to cause a short circuit of piezoelectric element 107. When the adhesives swell, the ink may leak from a gap generated by the swelling.

Thus, protective film 72 is formed on the whole of the liquid contact surface, i.e. an inner surface that would contact to the ink without the protective film 72, of head body 1 in the present exemplary embodiment, the head body including nozzle 101, pressure chamber 102, upstream individual flow path 103, downstream individual flow path 104, upstream common flow path 105, downstream common flow path 106, connection flow path 111, ink supply path 112, ink discharge path 113, and first to third adhesive layers 61 to 63.

Protective film 72 at this time is required to have chemical resistance not to be dissolved by ink and high adhesion to a base (such as nozzle plate 10). Thus, a metal oxide film or a resin film is used as protective film 72, for example.

Specifically, when the metal oxide film is used as protective film 72, titanium oxide, silicon oxide, aluminum oxide, niobium oxide, tantalum oxide, zirconia oxide, hafnium oxide, or the like may be used in a single film, or may be used in a stacked film obtained by combining two or more metal oxide films, for example. When the resin film is used as protective film 72, para-xylylene is used, for example.

In consideration of maintaining performance of ink-jet head 100, vibration plate 30 may include protective film 72 formed on the whole of the surface including the inner surface. For protective film 72, a resin film such as para-xylylene is preferably used in consideration of the material of vibration plate 30.

Depending on an object on which protective film 72 is formed, a different material may be used as protective film 72. When protective film 72 formed on the whole of the surface of vibration plate 30 is a first protective film, and protective film 72 covering the inner surface of the ink flow path is a second protective film, for example, a resin film may be used as the first protective film, and a metal oxide film may be used as the second protective film covering the inner surface.

Protective film 72 may be formed not only on the liquid contact surface of head body 1 but also on the inner surface of the whole of ink-jet head 100. Specifically, protective film 72 may be formed on at least a part of inner walls of supply pipe 2, collection pipe 3, joint 4, ink supply tank 5, and ink collection tank 6, in addition to the inner surface of head body 1.

### Method for Forming Protective Film 72

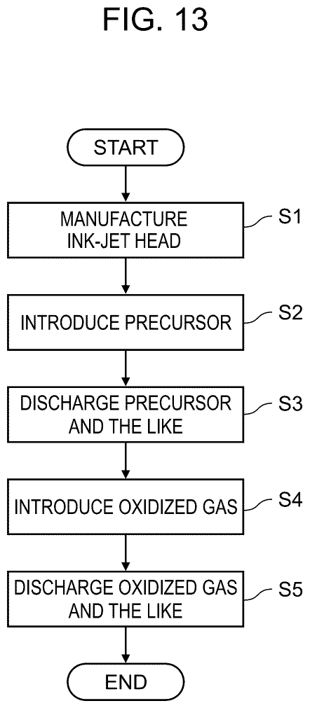

Next, a method for forming protective film 72 on ink-jet head 100 according to the present exemplary embodiment will be described. FIG. 13 is a flowchart showing an example of a flow of a film forming processing for ink-jet head 100 according to the present exemplary embodiment. Here, an example will be described in which protective film 72 is formed on the inner surface of the whole of ink-jet head 100 including head body 1.

In step S1, a head manufacturing step of manufacturing ink-jet head 100 is performed. In the head manufacturing step, nozzle plate 10 with a nozzle surface (surface on the positive side in the Z-axis direction) on which liquid-repellent film 71 is formed, flow path plate 20, vibration plate 30, and housing 40 are sequentially stacked, for example, and the plates are bonded to each other. Consequently, head body 1 in which the plurality of plates is stacked is manufactured.

At this time, first adhesive layer 61 is formed between nozzle plate 10 and flow path plate 20, and second adhesive layer 62 is formed between flow path plate 20 and vibration plate 30. Third adhesive layer 63 is then formed between vibration plate 30 and housing 40.

Then, joint 4 is attached to head body 1 manufactured, and joint 4 is connected to one end of each of supply pipe 2 and collection pipe 3. Consequently, ink-jet head 100 is manufactured.

Next, a film forming step of forming protective film 72 on the inner surface of head body 1 manufactured is performed. In the film forming step, an atomic layer deposition (ALD) is preferably used as a method of forming protective film 72, for example. This is because material of protective film 72 enters the ink flow path, which is a narrow space, and thus protective film 72 can be formed with a uniform thickness.

When protective film 72 is formed by the atomic layer deposition, a gas introduction port of a chamber (not illustrated) is first connected to the other end of supply pipe 2 of head body 1 manufactured. Then, a gas discharge port of the chamber is connected to the other end of collection pipe 3.

Next, a precursor serving as a precursor material to be a raw material of protective film 72 and being in a gasified state is supplied into head body 1 through supply pipe 2 and joint 4 in step S2. The precursor gas is appropriately selected in accordance with a type of protective film 72 to be formed. When protective film 72 is aluminum oxide (Al₂O₃), for example, gasified trimethylaluminum (Al (CH₃) ₃) is used as a precursor, for example. When protective film 72 is made of titanium oxide (TiO₂), for example, gasified tetrakis (dimethylamino) titanium (Ti (N (CH₃) ₂) ₄) is used as a precursor, for example. To improve adhesion of precursor molecules to a base, a step of introducing an OH group into the base may be performed before the step of introducing the precursor gas (step S2).

Next, excess precursor gas and methane (CH₄) as a by-product are discharged from the gas discharge port of the chamber through joint 4 and collection pipe 3 in step S3. For example, water and an oxidized gas such as oxygen plasma or ozone are supplied to a content part of head body 1 through supply pipe 2 and joint 4 in step S4. Then, excess oxidized gas and methane (CH₄) as a by-product are discharged from the gas discharge port of the chamber through joint 4 and collection pipe 3 in step S5.

As described above, the film forming step is performed on ink-jet head 100 having been manufactured, so that protective film 72 is formed on the whole of the inner surface of ink-jet head 100 including the ink flow path. Thus, corrosion and the like due to components of ink in the whole of the ink flow path can be suppressed.

The film forming step is performed while the respective plates constituting head body 1 are bonded in the present exemplary embodiment. Thus, protective film 72 is also formed on the inner surface of each of first to third adhesive layers 61 to 63, so that swelling of adhesives can be suppressed.

For example, protective film 72 may be formed on the inner surface of ink-jet head 100 excluding supply pipe 2 and collection pipe 3 in the present exemplary embodiment. For this configuration, a pipe for film formation is connected to joint 4 instead of supply pipe 2 and collection pipe 3 to manufacture ink-jet head 100, and then protective film 72 is formed inside head body 1 and joint 4 using the atomic layer deposition as described above. Then, supply pipe 2 and collection pipe 3 are connected to joint 4 after protective film 72 is formed.

Alternatively, protective film 72 may be formed on the inner surface of ink-jet head 100 excluding supply pipe 2, collection pipe 3, and joint 4, for example. For this configuration, a pipe and a joint for film formation are connected to head body 1 instead of supply pipe 2, collection pipe 3, and joint 4 to manufacture ink-jet head 100, and then protective film 72 is formed inside head body 1 using the atomic layer deposition as described above. Then, supply pipe 2, collection pipe 3, and joint 4 are connected to head body 1 after protective film 72 is formed.

As described above, ink-jet head 100 according to the present exemplary embodiment includes head body 1 that discharges ink from nozzles 101, and protective film 72 formed covering the whole of the inner surface with which the ink comes into contact in head body 1. When protective film 72 is formed on the whole of the inner surface of the head body 1 as described above, damage such as corrosion due to components of the ink is suppressed. Thus, the inner surface can be improved in chemical resistance to the ink.

### REFERENCE MARKS IN THE DRAWINGS

1: head body
2: supply pipe
3: collection pipe
4: joint
5: ink supply tank
6: ink collection tank
10: nozzle plate
20: flow path plate
30: vibration plate
40: housing
50: pressure fluctuation unit
61: first adhesive layer
62: second adhesive layer
63: third adhesive layer
71: liquid-repellent film
72: protective film
100: ink-jet head
101: nozzle
102: pressure chamber
103: upstream individual flow path
104: downstream individual flow path
105: upstream common flow path
106: downstream common flow path
106A: first part
106B: second part
106C: third part
106D: first downstream common flow path
106E: second downstream common flow path
107: piezoelectric element
111, 111A, 111B, 111C, 111D, 111E, 111F, 111G, 111H, 111I, 111J, 111K, 111L, 111M: connection flow path
112: ink supply path
113: ink discharge path
1000: printer

1. An ink-jet head comprising:
a head body including a nozzle that ejects ink; and
a protective film covering a whole of an inner surface of the head body.

2. The ink-jet head according to claim 1, wherein
the head body includes a vibration plate that is deformed by vibration of a piezoelectric element, and
the protective film covers a whole of the vibration plate.

3. The ink-jet head according to claim 2, wherein
the protective film includes a first protective film covering the whole of the vibration plate and a second protective film covering the inner surface, and
the first protective film comprises a material different from a material of the second protective film.

4. The ink-jet head according to claim 3, wherein the first protective film is a resin film.

5. The ink-jet head according to claim 1, further comprising a joint to which a pipe is connected,
wherein the protective film further covers an inner surface of the joint.

6. The ink-jet head according to claim 5,
wherein the protective film further covers an inside of the pipe.

7. The ink-jet head according to claim 6, further comprising an ink supply tank that supplies the ink or ink collection tank that collects the ink,
wherein the protective film further covers an inner wall of the ink supply tank or the ink collection tank.

8. The ink-jet head according to claim 1, wherein
the head body includes:
a nozzle plate;
a flow path plate;
a vibration plate;
a housing;
a first adhesive layer interposed between the nozzle plate and the flow path plate;
a second adhesive layer interposed between the flow path plate and the vibration plate; and
a third adhesive layer interposed between the vibration plate and the housing,
the first adhesive layer, the second adhesive layer, and the third adhesive layer constitute a part of the inner surface, and
the protective film covers the first adhesive layer, the second adhesive layer, and the third adhesive layer.
